(19) United States
(12) Patent Application Publication
(10) Pub. No.: US 2022/0253289 A1
(43) Pub. Date: Aug. 11, 2022

(54) WEB BROWSER BASED DEVELOPMENT PLATFORM FOR CREATING IoT WEB PAGES

(71) Applicant: Peng CHOO, Adelaide, South (AU)

(72) Inventor: Peng CHOO, Adelaide, South (AU)

(21) Appl. No.: 17/271,749

(22) PCT Filed: Jan. 3, 2019
(86) PCT No.: PCT/AU2019/050002

§ 371 Date: Feb. 26, 2021

(30) Foreign Application Priority Data
Aug. 28, 2018 (AU) 2018903157

(51) Int. Cl. G06F 8/34

(52) U.S. Cl. CPC G06F 8/34; H04L 67/02

(57) ABSTRACT

An internet of things IoT web page development platform for remote microcontroller device monitoring, control and display consisting of three layers. Layer one being the physical interface control for device input and output ports. Layer two being a communications controller that controls the layer one device and contains the user development environment and user developed web page. Layer three being the user's browser that displays and processes the web pages. The development platform is able to configure, control and sense ports directly from a web page. User's of the development platform can create a new IoT web page that includes systems outside the development platform such as systems on the user's device or resources on the communications network as part of the user developed web page.

### TECHNICAL FIELD

This invention relates to improvements in systems for creating web pages that link to control devices via remote connections.

### BACKGROUND TO THE INVENTION

Control devices (also called embedded devices, embedded controllers, embedded systems or microcontrollers) generally are devices whose primary purpose is to perform an independent action such as encoding video, controlling robots, routing internet traffic, and so on. Such devices run autonomously without user intervention, but there needs to be a way to program code into these devices.

The current generation of control devices with remote connections use standard off-the-shelf components such as operating systems, file systems and web servers in order to provide the networking and application tasks. These systems typically involve expensive and complex hardware designs and inefficient software designs. Due to such inefficiencies, these systems contain large amounts of code that require large amounts of RAM and high CPU speeds to support any reasonably robust networking infrastructure. This makes the devices expensive, difficult to program and unsuitable for certain applications.

For example, current systems have been developed that access control devices across networks such as the internet and graphically program them from a remote location. These internet of things IoT systems typically include remote servers that are far from the control device to act as communications controllers. Developers of IoT systems then need to create links to these servers on their apps or web pages to interface to the end user. These many steps have made IoT system development difficult and time consuming. One common development system uses over 100 lines of code to create a web page with on/off buttons interface to a controller. The development platform invention described here is able to create a web page with on/off buttons with only 2 lines of code.

### SUMMARY OF THE INVENTION

This software development platform is a browser based web page with user interface to the control device consisting of three software layers:

First the physical layer resides in the programmable control device and includes code for a control protocol that can activate ports, de-activate ports or read voltage levels. This first layer communicates with the second layer of code, the communications controller layer that contains code to transmit and receive web pages, typically, but not always, by wireless communication. The communications controller also contains a web page file that is transmitted to the user's web browser display device. This web page is the third layer and is executed on the user's display device. The development web page includes a user interface that enables the user to create another new web page that has access to output and input ports on the control device.

The development web page makes use of touch-screen and graphical interface devices that the user is likely to already own. It thereby simplifies and speeds the programming development cycle compared to previous systems. This way the programming code is available to the control device allowing it to be fully accessible and usable for programming on any device able to display and run web pages. It thereby eliminates the need for any specific hardware, operating system or server for the user to develop a custom web page interface and display incorporating control device outputs and inputs.

This three layer system allows both immediate and programmable control of output ports and both immediate display and user developed custom display of input signals as control parameters.

Since the physical input/output control device code only needs to perform interface functions on this system then the RAM and CPU speed needed are low thus allowing for a lower cost device to be used. Another advantage over previous systems is that the communications controller contains most of the code in the system and hence creates a flexible interface between many types of user interface devices and input/output control devices.

It is noted that the flexibility of this system is largely due to the fact that the communications controller is not compiling code for the physical input/output device, nor is the communications controller loading code into the physical input/output control device. This is one aspect that makes this system different from current programming of control devices with remote connections.

It is also noted that the communications controller can include an integrated physical input/output device or direct input/output ports. The communications controller would still command this device or ports in this case and the system can still be described in 3 layers even if the communications controller and physical input/output device are integrated onto the same hardware. The 2 layers of hardware still function with 3 layers of interface as described.

FIG. 1 shows how the three layers of interface code are connected and how they relate to the user.

When the web browser at the user device layer 3 requests the development web page, a web server in the communication control device at layer 2 provides a development web page. This development page accesses and controls the physical processor device at layer 1 by providing user buttons and selections to;
a) configure input and output ports on the device,
b) directly turn ports on or off,
c) monitor the state of any inputs on the ports including values from sensors that may be connected to any port.

This section of the development page also allows the user to name the ports for use by the new web page that is being created by the user.

The development web page or site includes a section for the user to add any JavaScript or other processing language that can be processed directly by the web browser on layer 3. The user may use the named ports in the processing language code to configure input and output ports, turn on or off ports or monitor the state of ports. Since this processing language can run in real-time it allows immediate display of the input/output states and input voltage values that have been set or acquired from the physical processor or micro-controller device at layer 1.

Yet another section of the development web page allows the user to add HTML and CSS code that forms the web page that is created by the user of this development platform. This user developed web page can be displayed in a preview window on the development page during development. The HTML and CSS code can access the user JavaScript code and port data so these can be displayed on the user developed web page or user developed buttons or other page input/output elements created by the user can interact with the JavaScript and control device ports both directly and indirectly.

The development platform web page has buttons to save all the user settings and code on the development page to the user's device that hosts the web page. These settings and code can also be saved to the layer 2 communication controller. Other buttons on the page can load the saved data from the user's device or the layer 2 communication controller.

When a web browser requests a main index page from the layer 2 communications device then the new web page created by the user and saved in the layer 2 communications controller is sent to the browser and the JavaScript or processing language is initiated to run. Thus a user of this development platform can create any web page to display and control any ports on the physical input/output device layer 1.

Unlike other development platforms it is noted that this invention can also access and use any function provided by the JavaScript or processing language made available by the web browser on the user's device level 3 even if these are not available from layer 1 control device or layer 2 communications controller. It is also noted that unlike other development platforms if the user device level 3 has access to the internet then any resource on the internet can be used on the new user web page developed on this software development platform.

### BRIEF DESCRIPTION OF THE DRAWINGS

The invention will now be described in more detail with reference to the following figures in which:

FIG. 1 shows how the three layers of interface code are connected and how they relate to the user.

FIG. 2 shows the connection path between the Controlled Outputs/Sensor inputs, the Layer 1 Physical input/output controller device with input/output ports, the Layer 2 Communications Device, the Layer 3 User Device and the User.

FIG. 3 depicts an exemplary graphical Code for the Layer 1 Physical input/output controller device.

FIG. 4 shows the user's device interface to the development platform open on a web browser.

FIG. 5 shows the development platform user interface sections in more detail.

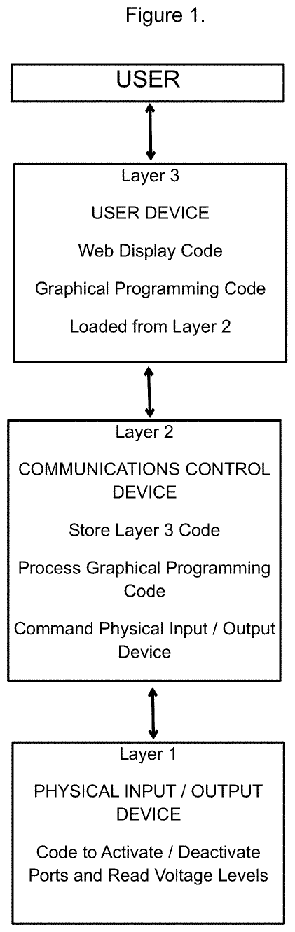

### DESCRIPTION OF THE PREFERRED EMBODIMENT

In accordance with the present invention;

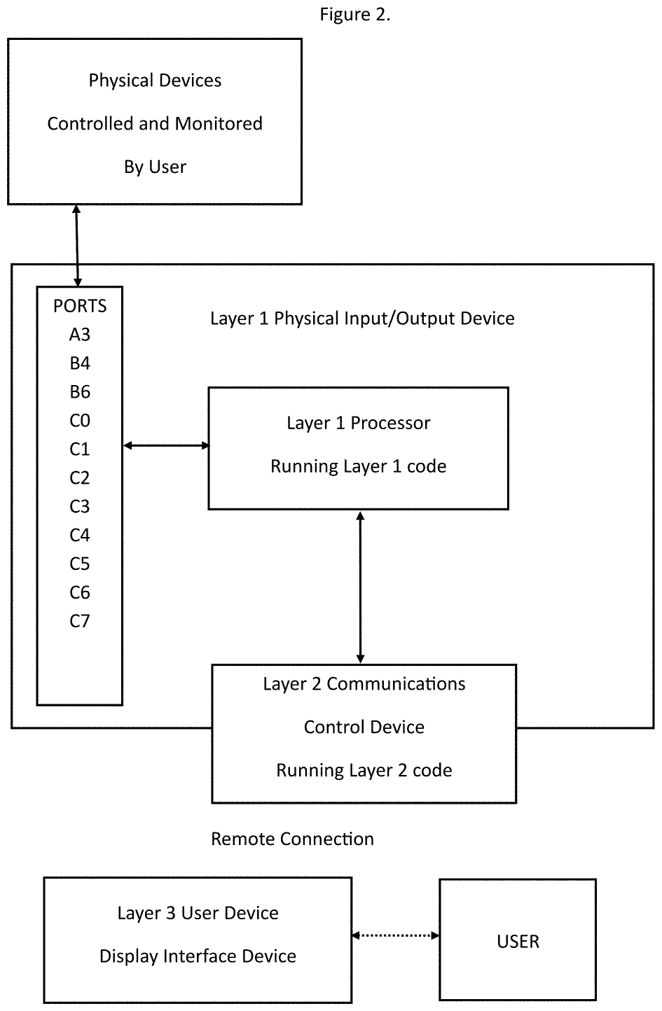

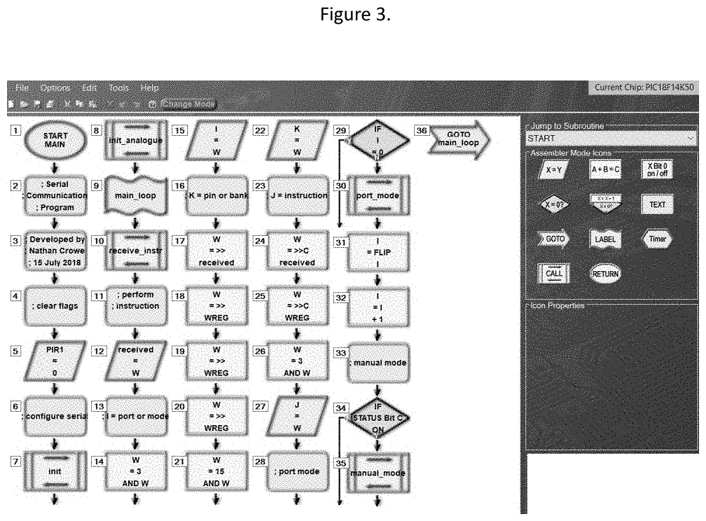

A layer 1 physical input/output controller device shown in FIG. 2 runs the code shown in FIG. 3. This port controller device has hardware and software communications interface to the Layer 2 communications control device. The Layer 2 communications device commands the port controller device to read port voltages or switch output ports on or off.

It is noted that the code in FIG. 3 is a graphical assembler. Although other coding methods can be used for the layer 1 physical input/output controller, a graphical assembler is preferred because this method improves the efficiency and ease of programming in assembly language while reducing the delays incurred in using higher level programming languages. The method comprising grouping together under one symbol, two or more assembly language instructions such that selection of that one symbol, together with one or more predetermined parameters, defines one of the two or more assembly language instructions. Two or more assembly language instructions are associated with a symbol. Upon selection of the symbol, the more specific operation of that symbol may be selected from any options available on that symbol. In this way, every opcode grouped under that symbol can be accessed and caused to perform its particular operation.

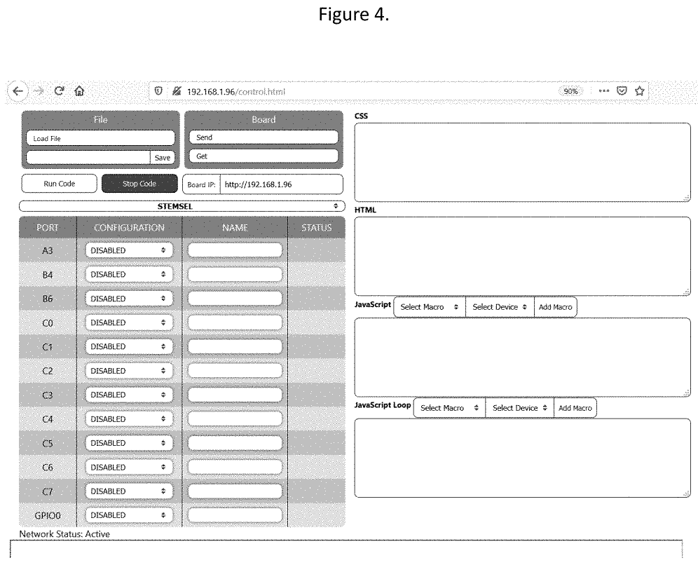

A layer 2 communications device shown in FIG. 2 serves a control and programming development web page to the Layer 3 User Device at the request of the user. This development web page is shown in FIG. 4.

Referring to more detail on the development platform web page in FIG. 4; The user configures microcontroller ports as required by selecting configuration options from a short pull down menu next to the port number. Options are; 1. Disabled 2. Digital Out 3. Digital In or 4. Analog In according to the availability of these options on the Layer 1 port controller device. Then a functionally descriptive name is typed next to the configuration options such as “WarningLED”, “ActivateButton” or “LightSensor”.

If the port is set as a Digital Out then the user can immediately test the connection by pressing the ON/OFF button that is in an OFF state to switch the output port, and any connected electrical component on. The ON/OFF button then shows an ON status. The ON/OFF button can then be pressed once again by the user to switch the output port, and any connected electrical component off.

If the port is set as a Digital In then the number 0 or 1 is displayed under STATUS to show a low or high reading from the port.

If the port is set as an Analog In then a number between 0 and 255 is displayed under STATUS representing an 8-bit voltage reading from the port.

Once configured, the port name can be directly referenced as a variable in the JavaScript or JavaScript Loop coding areas. Thus the inputs from the device ports can be used directly in the user developed code to make calculations and coded decisions. The JavaScript code an also switch Digital Out ports on or off when required.

The HTML coding area is for the user to develop a custom web page display that can include port variables, such as a custom on/off button interface or to display variables from the JavaScript areas including calculations made on ports or direct port readings.

The CSS coding area allows CSS graphics to be included on the user developed new web page.

As the code is being written by the user, it can be tested immediately by pressing the “Run Code” button above the port configuration area. The user developed web page is displayed in a window below the main development area.

The full development page contents including port configurations and code boxes can be downloaded as a saved file to the user device by entering a file name and pressing Save in the File area on the top left corner of the development area. A file can be loaded onto the development platform by pressing Load and selecting the file.

The development area configuration and code can also be saved directly to the Layer 2 Communications Controller by pressing the “Send” button on the Board section. Pressing the “Get” button will load the development area from the Layer 2 Communications Controller.

Once the development area configuration and code are saved to the Layer 2 Communications Controller, then the user can request the controller to serve the custom user web page by loading the main index page from the Layer 2 Communications Controller rather than the development platform page. Hence a new custom web page incorporating the input and output ports of the control device can be developed and deployed quickly and easily by users of this development platform.

### EXAMPLES OF USING THIS DEVELOPMENT PLATFORM

### Example 1: IoT Alarm System

This example will describe the steps to develop a sound alarm using this development platform.

The user will control a buzzer connected to port C4 of the microcontroller and detect the state of the button connected to port A3 of the microcontroller.

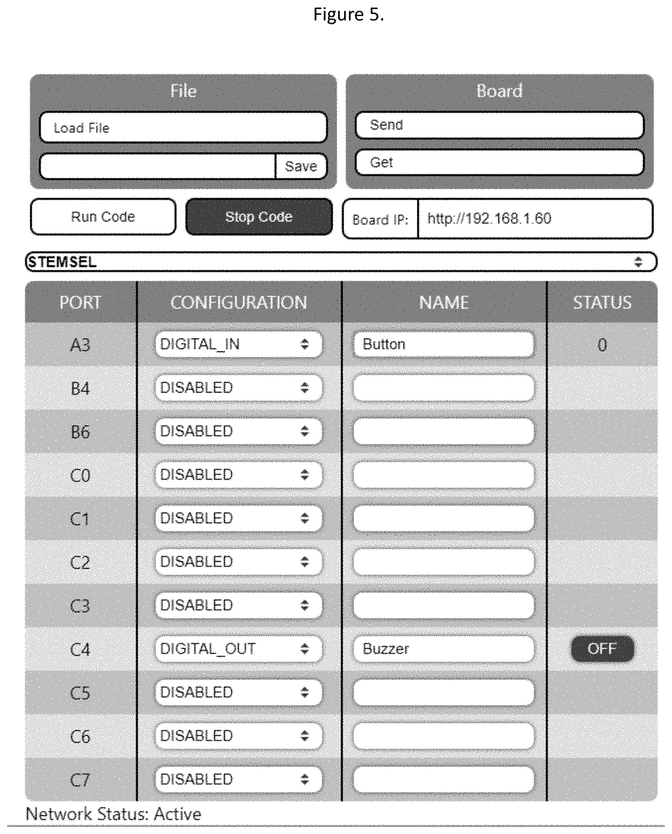

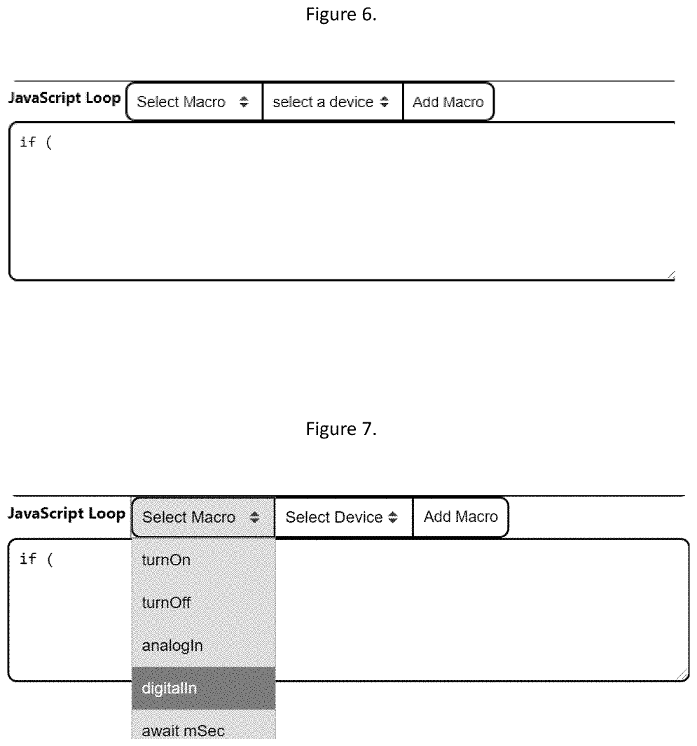

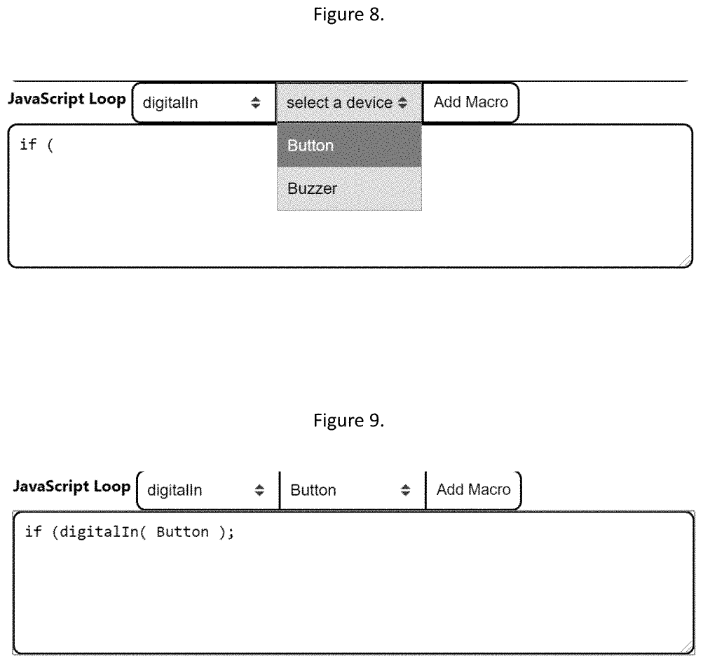

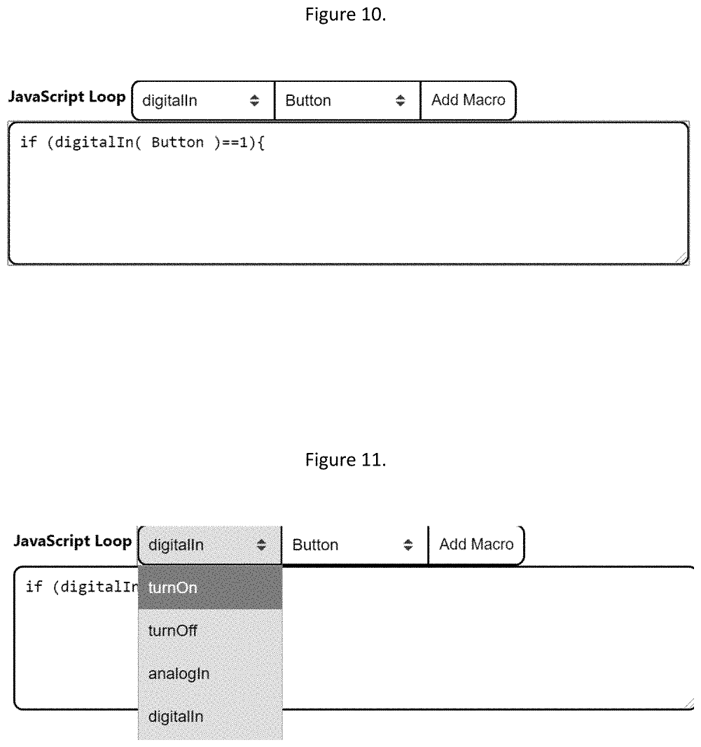

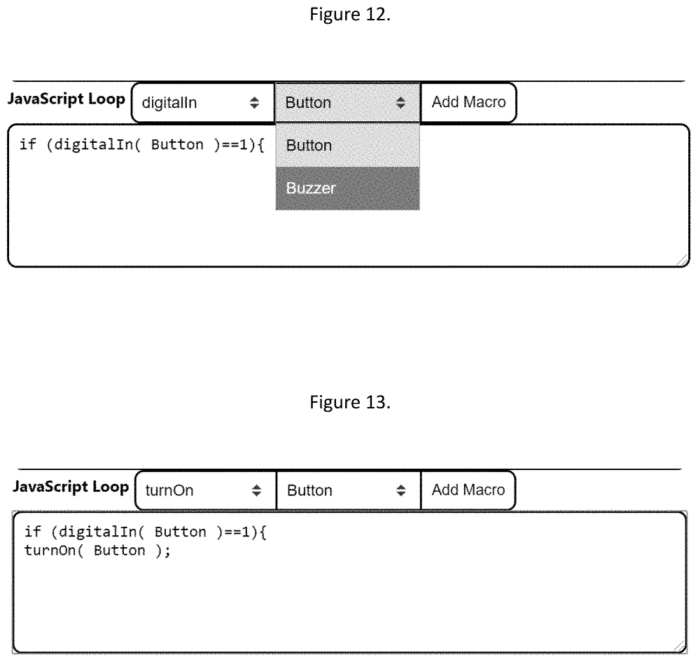

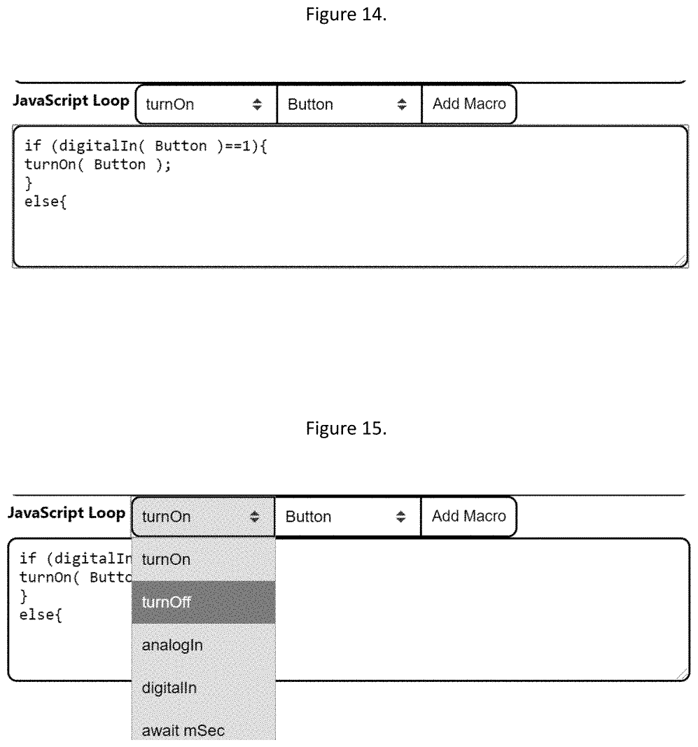

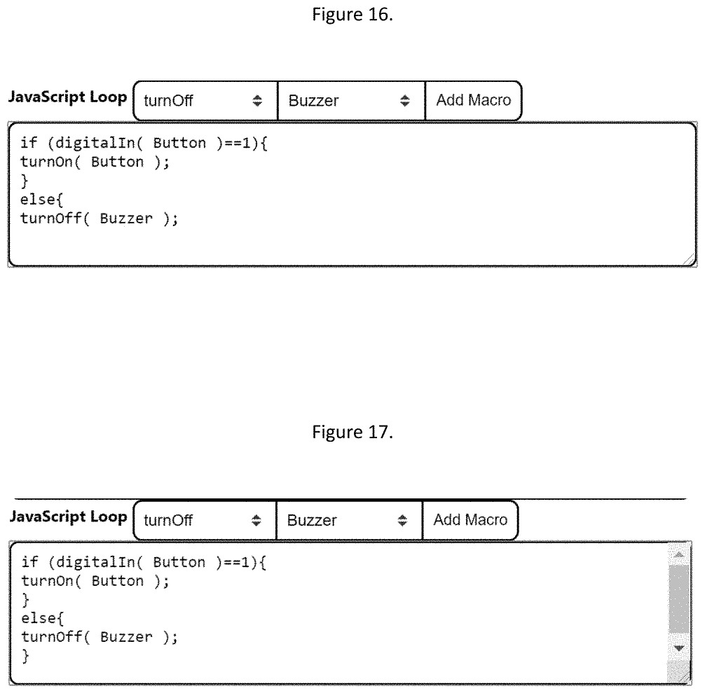

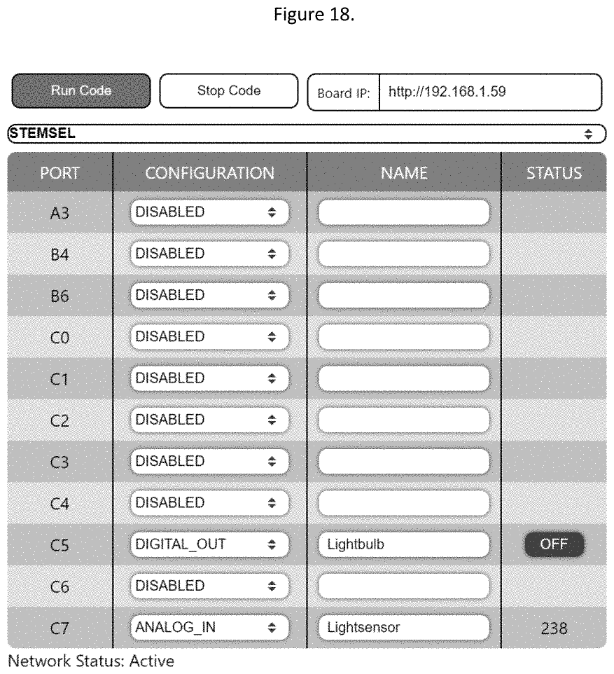

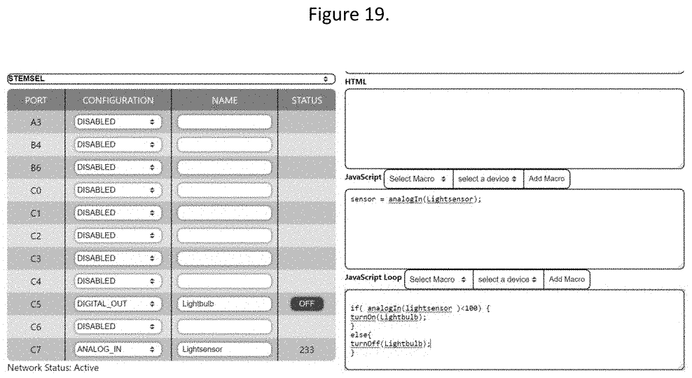

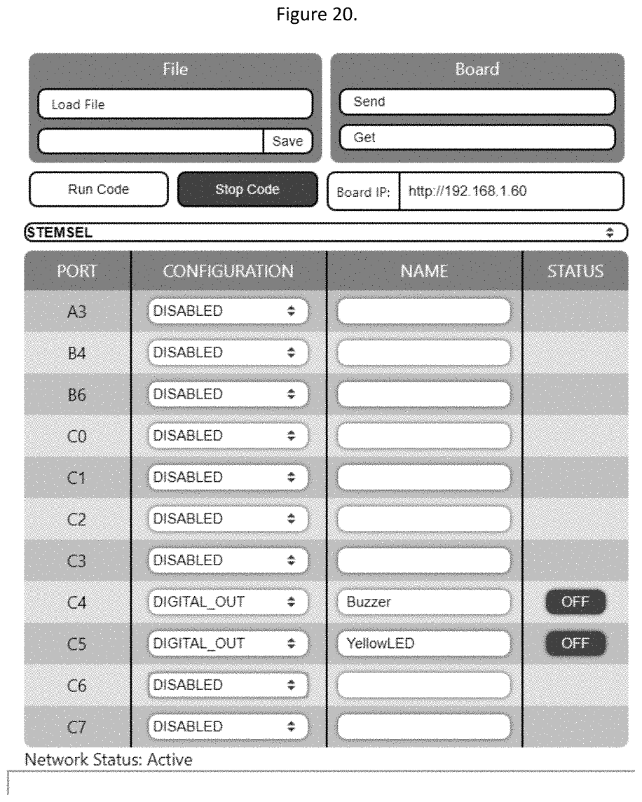

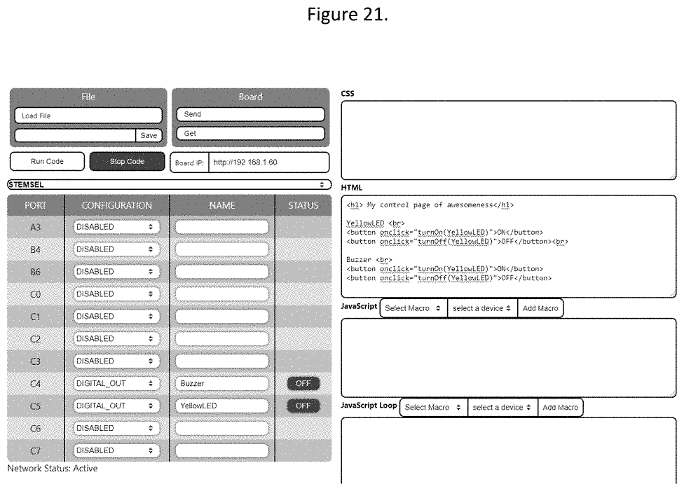

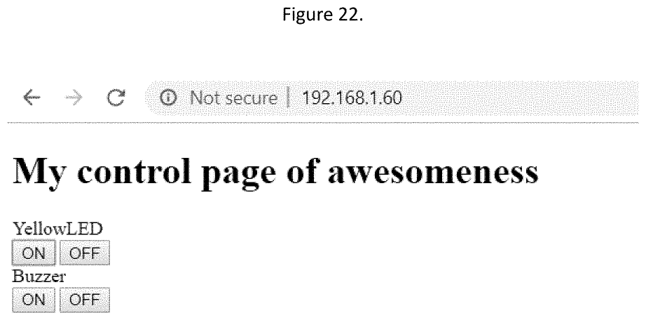

After connecting the devices to the microcontroller, the user interacts with the development platform as shown on FIG. 5. The user configures port A3 by selecting DIGITAL_IN and typing the name “Button”. The development platform then immediately reads the state of the microcontroller and displays 0 in STATUS to indicate a digital low signal on the microcontroller port input. Similarly, the user configures port C4 to DIGITAL_OUT and names it “Buzzer”. The development platform then immediately configures the C4 microcontroller port as a digital output and indicates that it is in a low state by displaying a red OFF button on the development platform interface. At this stage the user can test the buzzer connection by pressing the red OFF button to change the state of the microcontroller port and turn on the buzzer, and can press the button again to turn it back off.

The user can then interact with the development platform to create code that automatically turns on the buzzer if the button changes state. These steps are as follows;

FIG. 6; the user types “if (” into the JavaScript Loop box.

FIG. 7; the user selects “DigitalIn” from the “Select Macro” pull down menu.

FIG. 8; the user selects “Button” from the “Select a device” pull down menu.

FIG. 9; the user puts the text curser next to the “if (” in the JavaScript Loop box and then presses the “Add Macro” button. The “digitalIn(Button);” text is then automatically entered by the development platform.

FIG. 10; the user changes the “;” by deleting it and typing “==1({” thus completing the JavaScript code to test if the signal on the microcontroller port connected to the button is on.

FIG. 11; the user selects the “turnOn” function from the “Select Macro” menu.

FIG. 12; the user selects the “Buzzer” from the “select a device” pull down menu.

FIG. 13; the user places the text cursor on the next line in the JavaScript Loop box and presses the “Add Macro” button. The “turnOn(Buzzer);” text is then automatically entered by the development platform.

FIG. 14; the user types the “}” bracket on the next line and “else{” on the following line.

FIG. 15; the user selects the “turnOff” function from the “Select Macro” menu.

FIG. 16; the user places the text cursor on the next line in the JavaScript Loop box and presses the “Add Macro” button. The “turnOff(Buzzer);” text is then automatically entered by the development platform.

FIG. 17; the user finishes the code by adding a “}” bracket to the next line.

Since the code is finished, the user can now run the JavaScript code immediately by pressing the “Run Code” button near the top of the development platform page. As the code is running, the microcontroller buzzer output port is turned on or off in response to the button input port.

### Example 2: Lamp that Automatically Turns on when Light Level is Low and Off when Light Level is not Low

FIG. 18; the user configures port C5 as “Digital_Out” and names it “Lightbulb”. The user configures port C7 as “Analog_In” and names it “Lightsensor”. The STATUS of port C7 then immediately displays a reading of the microcontroller port C7 as a number between 0 to 255 and is updated in real time on the development platform display in response to the microcontroller port C7 input voltage.

FIG. 19; the user then follows steps similar to example 1 to enter the JavaScript and JavaScript Loop code but this time using the AnalogIn function to read the 0 to 255 reading from microcontroller port C7 to turn on the port C5 light when the reading is below 100 and turn off port C5 light when the reading if not below 100.

### Example 3: The User Creates a New IoT Web Page that Includes User Created Buttons to Control an LED and a Buzzer on the Microcontroller

FIG. 20; similar to previous examples, the user configures and names the buzzer and LED ports.

FIG. 21; the user types HTML code into the HTML box on the development platform and includes the “turnOn” and “turnOff” functions directly into the HTML button code by direct reference to the buzzer and LED names. Note that only 2 lines of code are needed to create an ON button and an OFF button.

By pressing the “Run Code” button on the development platform, the user can preview and test the functionality of the new web page and the created buttons in the section of the development platform page that is in a separate box below all the other elements of the development platform.

The user can then send the developed new web page to the communications controller in the development system, by pressing the “Send” button that in near the top of the development page in the “Board” section.

FIG. 22; the user can then access the new created web page as a separate page by entering the direct IP address of the communications controller in the web browser. The created buttons on the page are able to turn the buzzer and LED on or off.

These examples show how this development platform is much faster and easier to develop IoT web pages compared to previous systems.

The claims defining the invention are as follows:

1. A development platform to develop new web pages that allows both immediate and programmable control of microcontroller output ports and both immediate display and programmable use of microcontroller input signals as control parameters;
The three layers of the development platform consisting of:
a) A physical layer consisting of a programmable microcontroller device and including code for a control protocol that can activate ports, de-activate ports or read voltage levels. This layer communicates with;
b) A second layer of code contained in a communications controller to transmit and receive data from web pages, typically by wireless communication. The communications controller contains the development platform web page that is transmitted to;
c) A third layer user interface device hosting the development platform web page. This web page contains code that is executed by the browser on the user's interface device. The development platform web page includes a user interface for the user to develop a new web page. The new web page is able to communicate control commands to the second layer communications controller and receive sensor data from the communications controller.

2. A web page development platform according to claim 1 where the layer 1 physical input/output device code is programmed using a graphical assembler.

3. A web page development platform according to claim 1 where the communications control device at layer 2 includes an integrated physical input/output device or direct input/output ports that act as a layer 1 physical device.

4. A web page development platform according to claim 1 where the development user interface in layer 3 contains a programming language that is graphical.

5. A web page development platform according to claim 1 where the communications controller is not compiling code for the physical input/output device, nor is the communications controller loading code into the physical input/output control device.

6. A web page development platform running on a 3 layer programmable control system whereby a web browser at the user's device on layer 3 requests a web page user interface to the development platform and a web server in the communication controller at layer 2 provides the web page user interface that accesses and controls the microcontroller device at layer 1 by providing user buttons and selections to;
a) configure input and output ports on the microcontroller device,
b) directly turn microcontroller ports on or off,
c) monitor in real time the state of any microcontroller input ports including values from sensors that may be connected to any port.
d) enter port names that are immediately available as variables for the user to develop a new web page. The new web page being able to control microcontroller ports and use microcontroller sensor data in the new web page programming and display code.

7. A development platform according to claim 6 that is able to be configured to different layer 1 microcontrollers and port configurations by user selection.

8. A development platform according to claim 6 that includes user access to multiple programming languages to develop a new web page capable of processing microcontroller port output or input signals a web browser.

9. A development platform according to claims 6 and 7 that includes graphical selection of programming language commands and parameters, including parameters referring to microcontroller ports and port functions.

10. A development platform according to claim 6 that is able to access and use functions or resources provided by the programming language made available by the web browser on the user's device level 3 even if these are not available from layer 1 or layer 2 devices, including access to a wider network or access to devices, functions or resources on that network.

11. A development platform according to claim 6 that can deploy and run the user developed new web page, including functions accessing other layers on the system directly on the user's web browser without sending code to any other layer in the system.

12. A development platform according to claim 6 whereby user configuration and the user developed new web page can be saved or retrieved either on the layer 3 user's device or the layer 2 communications controller.

13. A development platform according to claim 6 whereby user developed new web page saved in the layer 2 communications device is executed directly by any web browser on the network when a direct request is made to the layer 2 communications controller.
